(19) United States
(12) Patent Application Publication
(10) Pub. No.: US 2005/0285901 A1
(43) Pub. Date: Dec. 29, 2005

(54) Ink jet nozzle geometry selection by laser ablation of thin walls

(75) Inventors: Shelby F. Nelson, Pittsford, NY (US); Eduardo M. Freire, Kennett Square, PA (US); John R. Andrews, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/880,069

(22) Filed: Jun. 29, 2004

(51) Int. Cl. B41J 2/04

(52) U.S. Cl. 347/54

(57) ABSTRACT

A novel method of fabricating the channel ends of an ink jet printhead: lithographically fabricating channels in photopolymer having the channel end blocked by a thin layer of photopolymer; sandwiching the photopolymer between two parallel substrates, one of which has an actuator for each channel; dicing through the substrates on a line perpendicular to the channels and leaving the channels and solid wall at the end of the channels intact; optionally coating the diced face including the polymer wall blocking the channel ends with a hydrophobic material; and forming nozzles in the end of the channels by laser ablating through the polymer layer at the end of the channel. Forming the nozzles after dicing and the optional coating prevents contamination of the interior of the printhead. The nozzles can be recessed from the diced edges of the substrate. Photolithographic formation of the end of the channel insures an accurate distance is maintained between the nozzle and the actuator. Improved jetting stability, directionality of the ejected drops, and drop size result from this novel fabrication method.

### FIELD OF THE INVENTION

The present invention generally relates to improved methods for fabricating thermal ink jet printheads—especially as relates to precisely controlling nozzle geometries to improve ink droplet directionality among other properties.

### BACKGROUND OF RELATED ART

The construction of micro electromechanical systems (MEMS) such as thermal ink jet printheads capable of dispersing small ink drops (on the order of picoliters, for example) during printing operations has become increasingly similar to fabrication techniques for micro electronics.

Ink jet printheads for handling small ink drops are fabricated in several steps. A group of channels is lithographically produced on a substrate, typically a silicon wafer, having actuators and microelectronics on it, by removing regions of photoresist material as is known in the art. The channels are covered with a second substrate that is typically glued to the surface of the photoresist. Many ink jet devices with an array of fluidic channels are created between the pair of substrates. When the rows of devices are diced, the ends of blind channels are exposed on the edge of the sandwiched pair of substrates. The blind channels are created by a thin layer of photopolymer that resides near the front end of the channels, with the channels extending behind the thin wall to the actuator, such as a heater in thermal ink jet. Other actuators could include electrostatic deflection plates or piezoelectric deflection plates. The channels continue further back to an ink supply as is known in the art. The thin wall may be flush with the diced surface or recessed from the diced edges of the substrates. The walls forming the channel ends can be made recessed by using the same photolithographic process used to form the channels. In the absence of further processing to form nozzles in the thin walls at the end of the channels, no fluid will flow through the device. The thin wall protects the interior of the device from being contaminated with dicing debris, detergents or other contaminants. While the channels are still closed at the front, a hydrophobic coating can be applied without contaminating the interior of the fluidic structures. Finally nozzles are formed in the thin end walls of the blind channels using a laser ablation process. The nozzles not only provide continuity of the fluid path, they provide the exit aperture from which drops are ejected and propelled toward a substrate.

U.S. Pat. No. 6,139,674 (hereafter “Markham patent”) issued to Roger G. Markham, et al., and also assigned to the assignee of the present Application for Letters Patent, discloses other general details about the fabrication of ink jet printheads, including the fabrication of filters for filtering impurities in the ink supply before ink enters the nozzle channels. The reader is referred to the Markham patent for other general details about the thermal ink jet printhead fabrication process.

Irregular or otherwise asymmetric nozzles can be a serious problem for any jetting device. These irregularities can be the result of limitations to the processing. For example, after the dicing process, surfactants used in the fabrication process and other debris often adhere to the internal channels defined by the nozzles. Further, the dicing process itself can introduce eccentricities around the nozzle in the form of burrs, chips, and other undesirable features of the dicing process. Because they may affect geometries, the aforementioned remnants of the fabrication and dicing processes can often cause exiting ink drops to veer off their intended paths resulting in “directionality” problems that can affect print quality. The prior art approach to addressing the problems of the remnants in the nozzle is to attempt to adequately remove the remnants during a cleaning process such as a plasma treatment. Often, however, remnants that may affect geometry and directionality still remain after cleaning. Also, the application of a hydrophobic coating can contaminate the interior fluidic pathways, leading to air entrapment or “depriming” of the channel.

There are other problems associated with prior art ink jet printhead fabrication techniques which rely on dicing to create the nozzle openings. For example, because there are often variations in distances between the nozzle openings and the heater, the dicing tolerances are often strict.

### SUMMARY

In view of the above-identified problems and limitations of the prior art, the present invention provides a method of fabricating ink jet printheads including: an array of lithographically fabricating channels having side walls formed from a photopolymer in which the end of the channels are closed by a thin layer of photopolymer; the thin layer forming the ends of the blind channels is exposed by dicing through the two substrates near the thin wall but outside the channel region leaving the thin wall intact; and nozzles are formed at the end of each channel by laser ablation through the thin wall at the end of each to facilitate exiting print drops during printing.

The present invention also provides an ink jet printhead that includes: a plurality of nozzles formed by laser ablation in a thin photopolymer that block the ends of photo lithographically formed channels; a substrate containing actuators and a capping substrate sandwiching the fluid structure in photopolymer so that the actuator can import motion to fluid in the channels; and a nozzle formed in the thin wall so that the actuator can drive ink drops out the nozzle; the two substrates and photopolymer are arranges so that dicing leaves the channel-blocking wall intact; and wherein for each channel, the thin wall includes a laser-ablated, well-defined hole to facilitate the formation of drops during actuation.

### BRIEF DESCRIPTION OF THE DRAWINGS

Features of the present invention will become apparent to those skilled in the art from the following description with reference to the drawings, in which:

FIG. 1 is a top view of a partially fabricated thermal printhead according to the present invention, prior to the dicing process.

FIG. 2 is a top view of the printhead in FIG. 1, after dicing and the formation of the nozzle by laser ablation.

FIG. 3 is a front view of the printhead of FIGS. 1 and 2.

FIG. 4 is a side view of the printhead of FIG. 2.

### DETAILED DESCRIPTION

The reader is again referred to the Markham patent for general details about the fabrication of ink jet printheads, and the general operation of ink jet printheads, as said reference is also incorporated by reference. Of note in the Markham patent is the use of laser ablation to construct a printhead filter, as the present invention also employs laser ablation, but for an entirely different purpose-to construct nozzle exit holes.

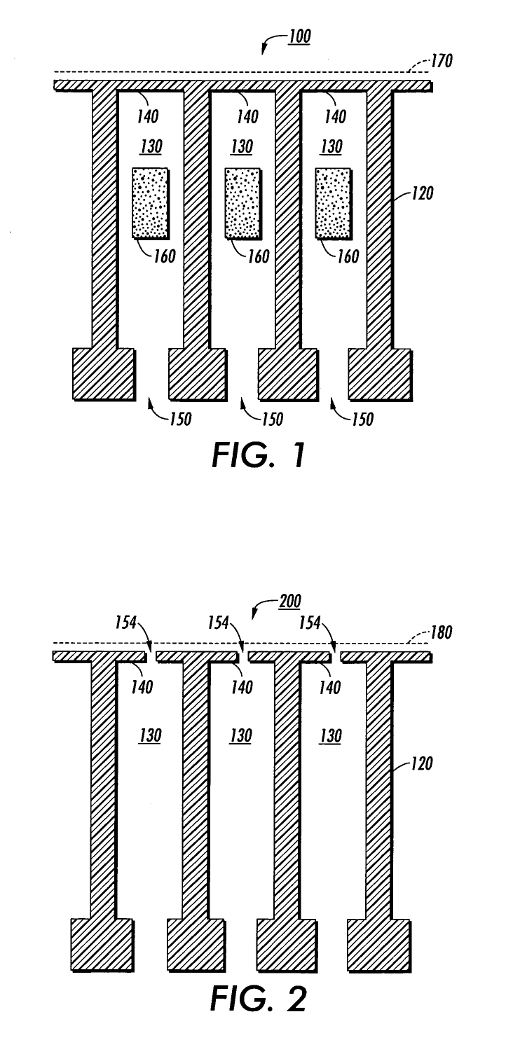

FIG. 1 illustrates the top view of the preferred embodiment for a partially fabricated thermal printhead 100. The printhead 100 is of the “side-shooting” type, although the present invention can be applied to other printhead types. In this figure, the following steps have already occurred. Walls such as those numbered 120 have been lithographically formed to create channels 130 having thin walls 140 blocking the one end of the channels and an opening to the manifold 150 at the opposite end of the channel. The actuator 160 is placed within the channel 130 between the entrance from the manifold 150 and the closed end of the channel 140.

It can also be seen from FIG. 1 that a dicing line 170 where the two substrates on top and below the shown polymer layers are diced to expose the thin wall 140 to the external environment. In the preferred embodiments, the various walls are constructed from a photoresist such as SU-8 or polyimide, although those skilled in the art to which the present invention pertains will appreciate that other photoresist material can be used. The thin wall 140 serves not only protects the channel 130 from debris and other contamination, it provides the material in which a nozzle is created by laser ablation. Formation of the nozzle in the wall 140 also allows the fluid length to remain constant even when the dicing line 170 moves closer or further from the thin wall 140.

FIG. 2 shows a top view of a fully formed ink jet printhead, which has had its end diced to form an edge in the substrate 180, followed by the forming of well-defined holes 154 in the thin channel end wall 140. The holes 154 are form by the ablation of portions of the channel end wall 140 by laser. Laser ablation allows for precise hole-shapes that are smaller than the mean cross-section of the channels, and because these holes are symmetrical with fewer eccentricities than are generally achievable by forming the holes via dicing, the directionality of the exiting ink drops is improved.

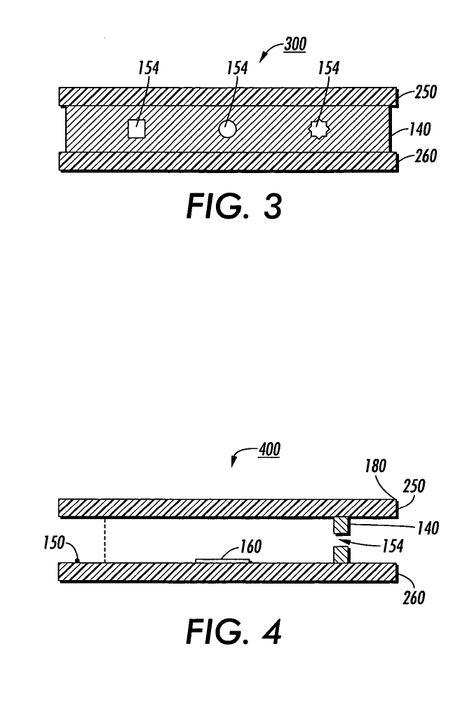

The front view of the fully fabricated ink jet printhead 300 is shown in FIG. 3. The thin polymer wall over the end of the channels 140 is sandwiched between an actuator substrate 260 and a cover substrate 250. It can be seen from FIG. 3 that the well-defined holes 154 forming nozzles in the channel end wall 140 can have many different shapes, such as a circular one (the preferred shape), a rhomboid one (such as a square), and star one. However, in the preferred embodiment, the hole shapes are the same for each nozzle. Unlike prior art approaches, the distance between the actuator 160 and the nozzle 154 is not tied to the actual dicing line 170, but is measured from the nozzle-block wall.

A side view of a single drop ejector 400 down the middle of the device is shown in FIG. 4. The actuator substrate 260 and capping substrate 250 form the top and bottom confinement for the channel. The actuator 150 creates fluid motion through by a mechanical means such as a growing bubble as in thermal ink jet or deflection of a piezoelectric element in piezo jetting devices. Fluid enters the device through the entrance from the manifold 150 and exits during actuation from the nozzle 154 as liquid droplets. Note once again that the lithographically formed front channel wall 140 defines the length of the fluid-containing region rather than the diced edge 180.

Experimental results are listed in Table 1 below for measurements of the undesirable touching of exiting ink drops against printhead structure members.

TABLE 1
MAXIMUM MISPLACEMENT FOR
WORST CASE DIRECTIONALITY

| | Xmax (K) | Ymax (K) | Xmax (C) | Ymax (C) |
|---|---|---|---|---|
| #Printheads | 9 | 9 | 28 | 28 |
| Mean | 29.0 | 31.8 | 22.3 | 20.6 |
| Sigma | 10.0 | 14.3 | 9.7 | 4.1 |
| Mean + 3 Sigma | 58.9 | 74.8 | 51.6 | 33.0 |

It has also been experimentally shown that for the worst case conditions, with a maximum Y (scan) misdirection of 80 microns at 1.3 mm, a total maximum wall height is 20 microns, assuming the nozzles are centered and have diameters of 15 microns (which is appropriate for drops of 5 picoliters), and the roof 250 and floor 260 can extend up to 40 microns before the drops will touch them.

Thus has been disclosed, an improved thermal ink jet printhead fabrication method which improves over prior art methods in several ways: improved directionality of ejected ink drops; a relaxing of dicing tolerances; a reduction or elimination of cleaning operations; increased dicing speeds; and reduced fluid friction, because of the thin front wall in which the nozzle is formed relative to large channel dimensions, leading to increased ink drop velocity, latency and recoverability, while maintaining favorable ink drop volume control, among other advantages.

Variations and modifications of the present invention are possible, given the above description. However, all variations and modifications which are obvious to those skilled in the art to which the present invention pertains are considered to be within the scope of the protection granted by this Letters Patent.

1. A method of fabricating ink exiting regions of thermal ink jet printheads comprising:
a) lithographically fabricating walls to form channels and an inlet to the channels from a fluid manifold area and an additional thin wall close one end of the channel;
b) two substrates forming approximately parallel walls approximately perpendicular to the polymer walls.
c) a thin polymer wall covering the exit from the channel
d) dicing through the two substrates perpendicular to the channel axis but leaving the channel and the thin wall closing the channel intact.
e) a nozzle for some or all of the channels formed in the thin polymer end to the channel by laser ablation.

2. The method of claim 1, where a hydrophobic coating is added prior to e).

3. The method of claim 1, wherein said nozzle has a circular shape.

4. The method of claim 1, wherein said nozzle has a rhomboid shape.

5. The method of claim 1, wherein said nozzle has a star shape.

6. The method of claim 1, wherein said nozzle has a square shape.

7. The method of claim 1, wherein said heater and channel layers comprise wafer structures.

8. The method of claim 1, where the side walls are made of SU-8 photo resist.

9. The method of claim 1 where the side walls are made of polyimide.

10. A thermal ink jet printhead comprising:
channels formed photolithographically in a photopolymer where the channels have an entrance from a fluid manifold and the exit is blocked by a thin wall of photopolymer;
approximately parallel substrates forming a second set of parallel walls approximately perpendicular to the polymer walls so that the substrate layers extend beyond the thin wall having the nozzle formed within it;
a fluid actuator within the within the channel;
dicing of the substrate layers perpendicular to the channel direction leaving the channel and thin channel-blocking wall intact;
a nozzle formed in the thin channel-blocking wall by laser ablation

11. The printhead of claim 10, where a hydrophobic coating has been applied to the thin polymer wall prior to formation of the nozzle.

12. The printhead of claim 10, where the nozzle has a circular shape.

13. The printhead of claim 10, where the nozzle has a rhomboid shape.

14. The printhead of claim 10, where the nozzle has a star shape.

15. The printhead of claim 10, where the nozzle has a square shape.

16. The printhead of claim 10, where the diced edge of the substrate extend beyond the nozzle in a direction parallel to the channel axis.

17. The printhead of claim 10, where the photopolymer is SU-8 photo resist.

18. The printhead of claim 10, where the photopolymer is polyimide photoresist.
